(19) United States
(12) Patent Application Publication
(10) Pub. No.: US 2014/0010924 A1
(43) Pub. Date: Jan. 9, 2014

(54) REMELTABLE HARD CANDY WITH IMPROVED FILLING

(71) Applicants: James E. Wilson, St. Charles, IL (US); Thomas Hinkemeyer, Gages Lake, IL (US)

(72) Inventors: James E. Wilson, St. Charles, IL (US); Thomas Hinkemeyer, Gages Lake, IL (US)

(73) Assignee: WILMELTS, St. Charles, IL (US)

(21) Appl. No.: 13/544,309

(22) Filed: Jul. 9, 2012

(51) Int. Cl. A23G 3/42; A23G 3/50; A23G 3/48; A23G 3/54; A23L 1/27

(52) U.S. Cl. 426/103; 426/660; 426/250

(57) ABSTRACT

A filled sugar candy made with a hard sugar candy outer shell encasing a liquid center filling is disclosed. The hard sugar candy outer shell consists essentially of sugar materials with a low moisture content, and with essentially no acid content. The center filling comprises at least about 63 dextrose equivalent (DE) corn syrup. The melted syrupy product is poured into molds and is allowed to cool, and the poured product becomes molded hard sugar candies. The candies can also be used to make brittle.

### BACKGROUND

1. Field of the Application

This disclosure relates to a method of producing homemade remelted and remolded hard sugar candies. The disclosure also relates to new and improved filled sugar candies for use in such method.

2. Description of the Related Art

It has been the practice of some home confectionery cooks to remelt hard sugar candies and to pour the melted material into candy molds, which are then allowed to cool, to produce molded hard sugar candies, which may have a shape appropriate for various holiday seasons, such as Thanksgiving, Christmas and Valentine's Day. Such home molded sugar candies are also widely used for cake decorations.

Certain hard sugar candies have been specifically made and commercially sold for remelting and remolding in home kitchens, to produce molded hard sugar candies. However, problems have been experienced with such commercially sold hard sugar candies, in that it has been difficult to remelt such candies. Excessive heat has been required to remelt such candies, whether the candies have been remelted in a hot conventional oven, on a stove top burner in a kettle, or in a microwave oven. The excessive heat has caused objectionable darkening and discoloration of the candies. Moreover, the melted candy material has been so viscous as to be difficult to pour into candy molds.

In one known method, filled sugar candy pieces are made with a hard sugar candy outer shell encasing a center filling made of a viscous liquid sugar syrup. The center filling syrup consists essentially of sugars with a moisture content of approximately 21 percent by weight, and with essentially no acid content. The sugars are preferably derived from sucrose, invert sugars and corn syrup. The corn syrup used in prior art methods is not highly viscous and will not melt without the presence of moisture. If the corn syrup is heated by itself, it will crystallize and turn into dextrose. The inclusion of the invert sugars allow the corn syrup to melt. However, in these prior art candies, getting the right mixture of invert sugars and corn syrup is difficult. Often the characteristics of the mixture are not predictable due to the variants in the raw materials and moisture content of the outer shell. If the mixture is not correct or the melting process is not closely controlled, the candy will burn and the product will become useless.

In the prior art method, the presence of the center filling syrup facilitates the melting of the filled sugar candy, so that the melting can be accomplished with low heat, and so as to minimize darkening or discoloration of the melted product.

### SUMMARY

The present disclosure provides an improvement to previous types of meltable hard candies. It has now been discovered that a corn syrup with a high dextrose equivalent rating provides beneficial characteristics as a center for meltable hard candy. It is noted that not any corn syrup will do. Indeed, normal corn syrup used in candy making and baking has a dextrose equivalent (DE) of 42. Such corn syrup does not provide an appropriate center for meltable candy without the admixture of other sugars such as invert sugars. Surprisingly, however, corn syrup with a DE of 63 has been found to be an effective liquid center for meltable hard candies. Because of its high viscosity and high sweetness level, DE 63 corn syrup has not generally been used by candy makers. Applicant has, however, found it to be particularly well suited for the present purposes.

The meltable candy filling of the present application is more consistent than previous fillings because it eliminates the need for uniformly mixing a large number of materials together. The meltable candy filling of the present application is also less expensive to produce than previous fillings.

In one embodiment, a meltable candy filling comprising at least about 98% 63 dextrose equivalent (DE) corn syrup is provided.

In another embodiment, a filled sugar candy is provided. The filled sugar candy consists of a meltable hard sugar outer shell and a liquid center filling. The hard sugar outer shell comprises a mixture of sugar and 42 dextrose equivalent (DE) corn syrup, and the liquid center filling comprises at least about 98% 63 DE corn syrup.

In yet another embodiment, a method for making a liquid filled meltable hard candy is provided. The method includes mixing hard candy material including sugar and 42 DE corn syrup, heating the hard candy material to a consistent liquid, cooling the liquid and creating a hard candy shell with a fillable center, filling the fillable center with a liquid filling comprising at least about 98% 63 DE corn syrup, and cooling the filled candy.

In yet another embodiment, a method for making brittle is provided. The method includes mixing a liquid filled meltable hard candy, soda of bicarbonate, salt, roasted nuts, and butter together, heating the mixture until melted, and pulling the melted mixture thin to cool. The liquid filling of the hard candy comprises at least about 98% 63 DE corn syrup.

These as well as other aspects and advantages will become apparent to those of ordinary skill in the art by reading the following detailed description, with reference where appropriate to the accompanying drawings. Further, it should be understood that the embodiments described in this summary and elsewhere are intended to illustrate the invention by way of example only.

### BRIEF DESCRIPTION OF THE DRAWINGS

Exemplary embodiments of the invention are described herein with reference to the drawings, in which:

FIG. 1 is a perspective view of a filled sugar candy in accordance with an embodiment; and

FIG. 2 is a sectional view of the filled sugar candy shown in FIG. 1.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present application provides a meltable candy filling made primarily of 63 dextrose equivalent (DE) corn syrup. The 63 DE corn syrup is highly viscous and will maintain a meltable texture at high temperatures. An example temperature range in which the filling can be heated is about 120° F. to about 200° F. In one embodiment, the 63 DE corn syrup may be Globe® Corn Syrup manufactured by Casco™.

The drawings illustrate a filled sugar candy 10 adapted specifically to be melted in home kitchens and poured into candy molds for use in producing homogeneous home molded hard sugar candies, for example. The drawings illustrate a single piece of the filled sugar candy 10. Like other filled sugar candies, the candy 10 can be made in large quantities at a high production rate by sugar candy making machines, which are well known to those skilled in the art.

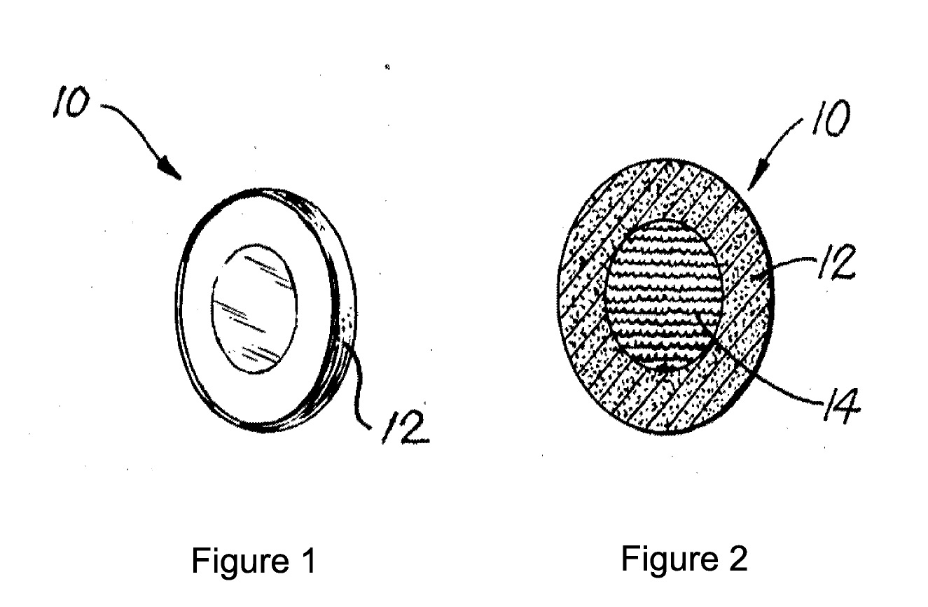

FIG. 1 shows a filled sugar candy 10 having a hard meltable sugar outer shell 12 and a liquid center filling 14, which is shown in FIG. 2. It will be understood that the filled sugar candy 10 is shown diagrammatically in the drawings, and that the configuration of the candy 10, the outer shell 12, and the center filling 14 may vary widely. Thus, those skilled in the art are able to make filled sugar candy in a wide variety of sizes and shapes, by using different molds and different machines, for example. Moreover, the center filling 14 may be varied in size and shape.

The hard sugar candy outer shell 12 consists of sugar materials with a low moisture content, less than two percent by weight, and with essentially no acid content. The sugar materials are preferably derived entirely from sucrose and a corn syrup having the necessary melting characteristics, such as 42 DE corn syrup. However, any appropriate hard candy shell with the necessary melting characteristics would be within the scope of the present invention.

Citric acid is widely used in hard sugar candies, but the hard sugar candy outer shell 12 of the filled sugar candy 10 should not include any significant acid content, and preferably should be entirely free of any acid content. The presence of any significant acid content has the effect of darkening and discoloring the candy when it is heated sufficiently to remelt the candy. The acid has this effect, when heat is applied, because the acid causes the breakdown of some of the sucrose by hydrolysis into dextrose and levulose, which are subject to darkening and discoloration by the heat which is necessary to remelt the candy.

The center filling 14 comprises at least about 98% 63 DE corn syrup. The 63 DE corn syrup is highly viscous and will therefore maintain a meltable texture at high temperatures without the need to add moisture. The temperature range at which the filling 14 may be flowable is about 120° F. to about 210° F., for example. The center filling 14 may also include additional supplementary components, such as coloring and/or flavor. The center filling 14 of the filled sugar candy 10 preferably ranges from about 13 to about 16 percent by weight of the filled sugar candy, the remainder being the hard sugar candy outer shell 12.

In the method of the present invention, the filled sugar candy 10 is made, preferably in large quantities, by a candy factory. A batch, containing one or more of the filled sugar candies 10, is then melted by the application of heat and agitation, to produce a hot viscous syrupy product which homogeneously combines the hard sugar candy outer shell 12 and the center filling 14. The hot viscous syrupy product is then poured into molds, such as plastic or metal candy molds. The poured product and the molds are then cooled, and the poured product becomes molded hard sugar candies which are homogeneous. The melting, pouring and molding steps are typically performed in a home kitchen by a home confectionery cook. The molded candies may be molded in shapes which are appropriate for holiday seasons, such as Thanksgiving, Christmas and Valentine's Day. Moreover, the molded candies may be used as cake decorations for birthday cakes and other cakes for special observances.

The melted syrupy product is preferably stirred or otherwise agitated sufficiently to make it homogeneous. The high viscosity of the 63 DE corn syrup facilitates the pouring of the melted corn syrup filling into candy molds by flowing consistently into the molds and not creating large lumps.

In one example method, hard candy is prepared by cooking a mixture of 60% sugar and 40% corn syrup to about 295° F. The melted mixture is placed onto a cooling table and cooled onto a sheet. The mixture is maintained at about 150° F. on a warming table, for example. The outer shell 12 is then formed with a trough in the center, and 100 grams of 63 DE corn syrup is placed in the trough. Color and/or flavoring may also be added to the candy.

In another embodiment, a method for making a brittle, such as peanut or almond brittle, using the meltable hard candy of the present invention is disclosed. The brittle is made by mixing about 180 grams of the hard candy described above with soda of bicarbonate (about 1 gram), salt (about 1.8 grams), nuts, such as peanuts, cashews, walnuts, or almonds (46 grams), and butter (about 12 grams). The ingredients are then heated until melted together at an appropriate temperature, poured onto a cooling slab, and pulled thin to cool.

### EXAMPLES

### Example 1

Butterscotch liquid filled hard candy:

Prepare hard candy by cooking 60% sugar and 40% corn syrup to 295° F. Place the cooked mixture on to a cooling table to cool into a sheet. Pace on a warm table of about 150° F. with an infrared lamp above. Make a trough using ¾ inch bars and using 400 g of hard candy mixture. Pour 100 g of 63 DE corn syrup into the trough. Moisten the edges with a damp towel and seal the edges to entrap liquid. Form the candy into a rope by using rollers, for example. Stretch the rope thinner and place onto a pillow cutter which will form a pillow piece of candy. Slowly apply pressure while cutting and sealing edges with the cutter. Remove, cool, and cut.

Hard Candy Jacket:

| | | Dry Base | | % reducing |
|---|---|---|---|---|
| | Grams as is | (solids) | % Dry Base | sugar |
| Sugar | 60 | 60 | 64.935 | 0 |
| Corn Syrup | 40 | 32.4 | 35.065 | 14.73 |
| Water | 20 | 0 | 0 | 0 |

### Cook to 310 ° F.

Filling—63 DE corn syrup from Chicago Sweeteners, water activity of 0.67
Prepare butterscotch flavored and colored 63 DE corn syrup.

| | | | % reducing |
|---|---|---|---|
| | Grams | % | sugar |
| 63 DE Corn Syrup | 100 | 99.256 | 62.53 |
| N&A Butterscotch flavor, | 0.35 | 0.347 | 0 |
| #25.32481 | | | |
| Caramel color 50% solution, DS | 0.4 | 0.397 | 0 |
| 400 Sethness | | | |

Scale 400 grams of cooked hard candy and incorporate 1.4 grams (0.35% by finished weight of hard candy mass) N&A Butterscotch flavor, #25.32481.

### Example 2

Butterscotch liquid filled hard candy at 16% filling:

Hard candy shell:

| | | % reducing |
|---|---|---|
| | % | sugar |
| Sugar | 54.55 | 0 |
| Corn Syrup 42 | 29.45 | 12.37 |
| DE | | |

### Filling:

| | | % reducing |
|---|---|---|
| | % | sugar |
| Corn Syrup 63 DE | 15.88 | 10 |
| Caramel color 50% | 0.06 | 0 |
| solution, DS 400 Sethness | | |
| N&A Butterscotch flavor, | 0.06 | 0 |
| #25.32481 | | |

Moisture of filling: 18.5%

### Example 3

Hard candy jacket:

| | | Dry Base | | % reducing |
|---|---|---|---|---|
| | Grams as is | (solids) | % Dry Base | sugar |
| Sugar | 55 | 55 | 60.287 | 0 |
| Corn Syrup | 45 | 36.23 | 39.713 | 16.68 |
| Water | 20 | 0 | 0 | 0 |

### Cook to 310° F.

Filling: 63 DE corn syrup from Chicago Sweeteners, water activity of 0.67

### Example 4

Finished product at 16% filling:
Hard candy shell:

| | | % reducing |
|---|---|---|
| | % | sugar |
| Sugar | 50.64 | 0 |
| Corn Syrup 42 | 33.36 | 14.01 |
| DE | | |

### Filling:

| | | % reducing |
|---|---|---|
| | % | sugar |
| Corn Syrup 63 DE | 15.88 | 10 |
| Caramel color 50% | 0.06 | 0 |
| solution, DS 400 Sethness | | |
| N&A Butterscotch flavor, | 0.06 | 0 |
| #25.32481 | | |

Moisture of filling: 18.5%
Moisture of hard candy under 2%

### Example 5

Heat a filler, such as Euromec or any other known brand, and line for the run at a temperature of 130° F. Heat corn syrup filling in a separate kettle to 160° F., and place filling into the hard candy shell.

| | | | Filling amount | Filling amount calculated through |
|---|---|---|---|---|
| | Temperature | Pump | calculated through | weight analysis from the 3 box of |
| | of filling | Setting | moisture analysis | every run |
| Trial 1 | 160° F. | 37.5 | See Table 1 | 12.8, 23, 18, 13.8, ave % filling 16.8% |
| Trial 2 | 130° F. | 42 | See Table 1 | 18.7, 18, 18.3, ave % filling 18.33% |
| Trial 3 | 130° F. | 45 | See Table 1 | 20.83, 20, 21.83, ave % filling 20.88% |

TABLE 1
Filling amount calculated through moisture analysis

| | | | | | Min/ | |
|---|---|---|---|---|---|---|
| Run | Moisture | Hard Candy | Filling | Average | Max | Std Dev |
| 3 | 4.02 | 81.28 | 18.72 | 20.17 | 18.72 | 2.102691 |
| 3 | 4.8 | 76.74 | 23.26 | | 23.26 | |
| 3 | 4.06 | 81.05 | 18.95 | | | |
| 3 | 4.2 | 80.23 | 19.77 | | | |
| 2 | 3.8 | 82.56 | 17.44 | 17.83 | 17.15 | 0.560074 |
| 2 | 3.75 | 82.85 | 17.15 | | 18.60 | |
| 2 | 3.9 | 81.98 | 18.02 | | | |
| 2 | 4 | 81.40 | 18.60 | | | |
| 2 | 3.88 | 82.09 | 17.91 | | | |
| 1 | 2.5 | 90.12 | 9.88 | 13.16 | 9.88 | 3.149639 |
| 1 | 3 | 87.21 | 12.79 | | 17.44 | |
| 1 | 3.8 | 82.56 | 17.44 | | | |
| 1 | 2.62 | 89.42 | 10.58 | | | |
| 1 | 3.4 | 84.88 | 15.12 | | | |

Various example embodiments have been described. The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. Further, many of the elements that are described are functional entities that may be implemented as discrete or distributed components or in conjunction with other components, in any suitable combination and location.

1. A meltable candy filling comprising at least 98% 63 dextrose equivalent (DE) corn syrup.

2. The meltable candy filling of claim 1 further comprising coloring or flavoring.

3. A filled sugar candy consisting of a hard sugar outer shell and a meltable center filling, wherein the hard sugar outer shell consists essentially of sugar and 42 dextrose equivalent (DE) corn syrup, and wherein the meltable center filling comprises at least about 98% 63 DE corn syrup.

4. The filled sugar candy of claim 3 wherein the center filling ranges from about 13 to about 16 percent by weight of the filled sugar candy.

5. The filled sugar candy of claim 3 further comprising coloring or flavoring.

6. A method of making a liquid filled meltable hard candy, comprising the steps of:
mixing hard candy material comprising sugar and 42 DE corn syrup;
heating the hard candy material to a consistent liquid;
cooling the liquid and creating a hard candy shell with a fillable center;
filling the fillable center with a liquid filling comprising at least about 98% 63 DE corn syrup; and
cooling the filled candy.

7. The method of claim 6 wherein the liquid filling further comprises coloring or flavoring.

8. The method of claim 6 wherein the liquid filling ranges from about 13 to about 16 percent by weight of the meltable hard candy.

9. A method of making brittle comprising:
mixing a liquid filled meltable hard candy, soda of bicarbonate, salt, roasted nuts, and butter together, wherein the liquid filling of the hard candy comprises at least about 98% 63 DE corn syrup;
heating the mixture until melted; and
pulling the melted mixture thin to cool.

10. The method of claim 9 wherein the nuts comprise almonds, cashews, peanuts, or walnuts.
